(19) United States
(12) Patent Application Publication
(10) Pub. No.: US 2009/0254847 A1
(43) Pub. Date: Oct. 8, 2009

(54) ANALYSIS OF VISUALLY-PRESENTED DATA

(75) Inventors: Scott J. Counts, Seattle, WA (US); Paul R. Johns, Tacoma, WA (US); Aaron C. Hoff, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/060,884

(22) Filed: Apr. 2, 2008

(51) Int. Cl. G06F 3/048

(52) U.S. Cl. 715/771

(57) ABSTRACT

A person may interact with visually-presented data in order to specify an analysis to be performed on the data. Data may be presented through a browser or other program in a visual form, such as a chart or graph. The person may interact with the visual presentation of the data in order to choose a specific body of data or a portion thereof. An analysis may be performed on the chosen data. The analysis to be performed may be selected based on features of the data and/or based on the person's indication of which analysis is to be performed. A decision tree may be used to choose the particular analysis to be performed.

### BACKGROUND

Data of various kinds are widely available through sources such as web sites, news feeds, etc. Examples of such data include data about weather, traffic, economic facts, etc. It may be difficult to discern meanings, trends, and patterns in raw data, so people who have obtained data often seek to analyze the data in some way. Many of the analyses that people intuitively wish to perform are based on statistical models, or other formal disciplines. Most people, however, do not have training in these disciplines. A person may have a question about data, but may not be able to identify the particular type of statistical analysis that would answer the question, and may not be able to set up the mathematics to perform the analysis.

For example, one might have data about traffic and pollution and might ask whether traffic increases when pollution increase. In the language of statistics, to ask this question is to ask whether two variable correlate. While a person might be interested in the relationship between traffic and pollution, that person may not recognize the appropriate statistical model to determine whether such a relationship exists. Tools for data analysis exist, but using these tools often involves some knowledge of statistics. Moreover, some people may wish to interact with the data on a visual level that is not provided by these tools.

### SUMMARY

A system may be provided that performs analysis of selected data. The system may provide a visual interface that shows a representation of data in a visual form, such as a graph, chart, etc. A person may interact with the visual representation of the data in order to select data to be analyzed. The system could select a particular analysis to be performed on the data (e.g., a statistical correlation or comparison). The choice of which analysis to perform may be based on certain features of the data, such as the number of variables involved. The choice may also be based on input from a person. The system performs the requested analysis and provides a result. For example, if one wants to know if pollution and rainfall are correlated, one could use the system to view data about both rainfall and pollution within a given time period, and could then ask the system to assess the degree to which the data correlate, e.g., by clicking on or otherwise selecting these two variables in the visual interface. The person may be able find out the correlation between these variables without specifically knowing about statistical correlation. For example, the person could click a button with a less technical term (e.g., “relationship”), or, the system could determine, from the nature of the data, that statistical correlation is an appropriate analysis to perform on these data, and could then perform that analysis.

In one example, the system includes an application that implements a visual interface to data. The application may create and provide web pages that contain visual representations of the data, and that allow the user to interact with the data. A person may interact with a visual representation of the data using a browser. The application may interpret, from the person's interactions with the visual representation, a request to perform an analysis, and may then issue the appropriate instructions to have the analysis performed. For example, a commercial database system may have the tools to perform statistical analysis on data, and the application could issue a request to the database system to have the analysis performed. Alternatively, the statistical analyses may be proprietary or may reside in a middleware or any other system component. The system may use a decision tree, or any other technique such as a Bayesian probability model, to determine the appropriate analysis to request. The decision may take into account factors such as the number of variables in the data, the quantity of data provided, or any other factors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram an example process in which data is analyzed.

FIG. 2 is a flow diagram of an example process in which a decision tree is used to decide which test to perform on one or more data sets.

FIG. 3 is a diagram of an example visual representation of data, with which a person may interact.

FIG. 4 is a block diagram of an example decision tree.

FIG. 5 is a block diagram of example components that may be used in connection with implementations of the subject matter described herein.

### DETAILED DESCRIPTION

Data on a number of topics has become more available in recent years. People may use this data to answer factual questions (e.g., how does rainfall affect pollution). One way to make it convenient for a person to work with data is to provide a system that presents the data in an interactive visual form, and helps the person choose a statistical analysis that is appropriate for the type of data and for the question that the person is trying to answer. For example, data could be presented through a web browser in the form of a graph, chart, or some other visual representation. A person could use the web browser to identify some portion of the data (which may be all of the data, or less than all of the data)—e.g., by selecting particular data points, sets of data points, regions of a graph, etc. The person could then select a particular type of analysis to perform on the data, or the person could specify some general type of command such as “compare” or “find relationships” with regard to the selected data, or the system could suggest an analysis based on the nature of the data selected (e.g., different analyses may be appropriate, depending on the number of variables in the data, or the number of different sources of data). Such a system may allow a person to use statistical analysis on the data to answer questions (such as whether rainfall correlates with pollution). A person may be able to use the system to answer these questions, even if the person lacks training in statistics.

For example, a person may wish to know whether, and to what degree, rainfall eases air pollution. Data for both rainfall and pollution levels are commonly available for many parts of the world. The person may create a time series chart of rainfall and pollution levels for a particular geographic area (or may use an existing chart, if it exists). Rainfall and pollution lines in the chart may be selected by clicking portions of the chart with a pointing device. There may be a “correlate” or “relationship” button that that the person may click to obtain correlation relationship between the two time series. Or, a system could determine, based on the nature of the data selected, that correlation is an appropriate analysis to perform, and may be perform this without explicit selection from a user. Similarly, the person could compare pollution levels in the summer and winter, by drag-selecting two regions of the pollution line, one corresponding to summer and one to winter, and then clicking a “compare” button. The system may recognize that the selected data are appropriate for a t-test statistical comparison. In this case, the system may perform that analysis and may report whether, and to what degree, summer pollution levels are higher than winter pollution levels. The foregoing is an example of how a user could interact with a visual representation of data in order to perform statistical analyses. Any other data analyses could be performed, including but not limited to linear regressions and analysis of variants (ANOVAs), as well as effect size estimates in lieu of or in combination with these statistical analyses.

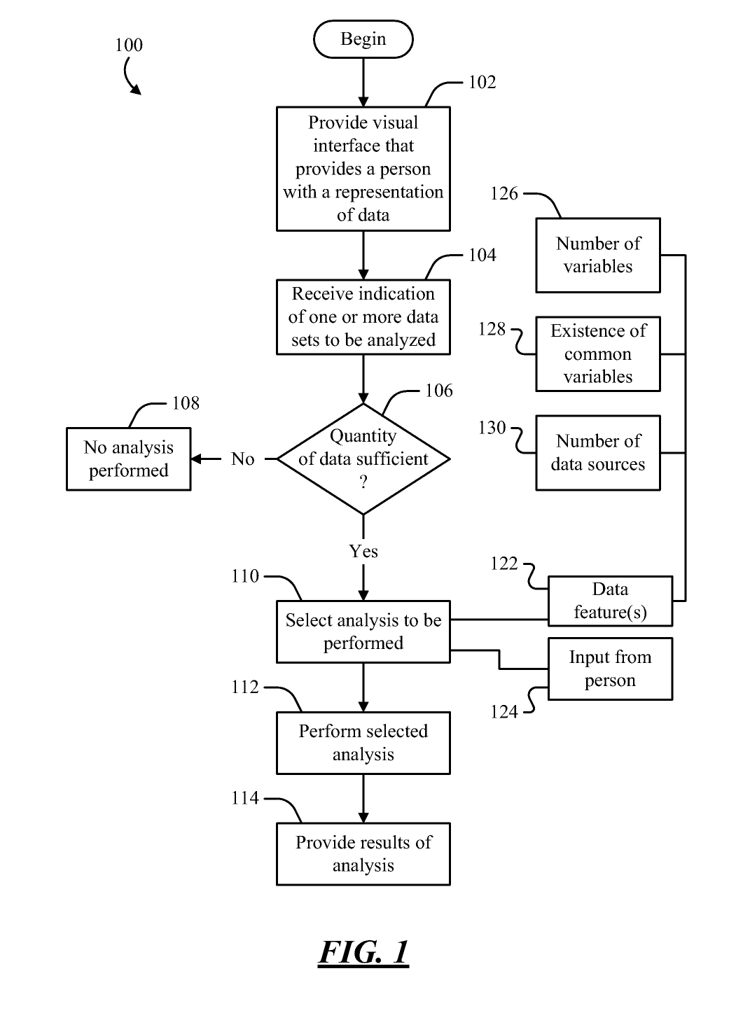

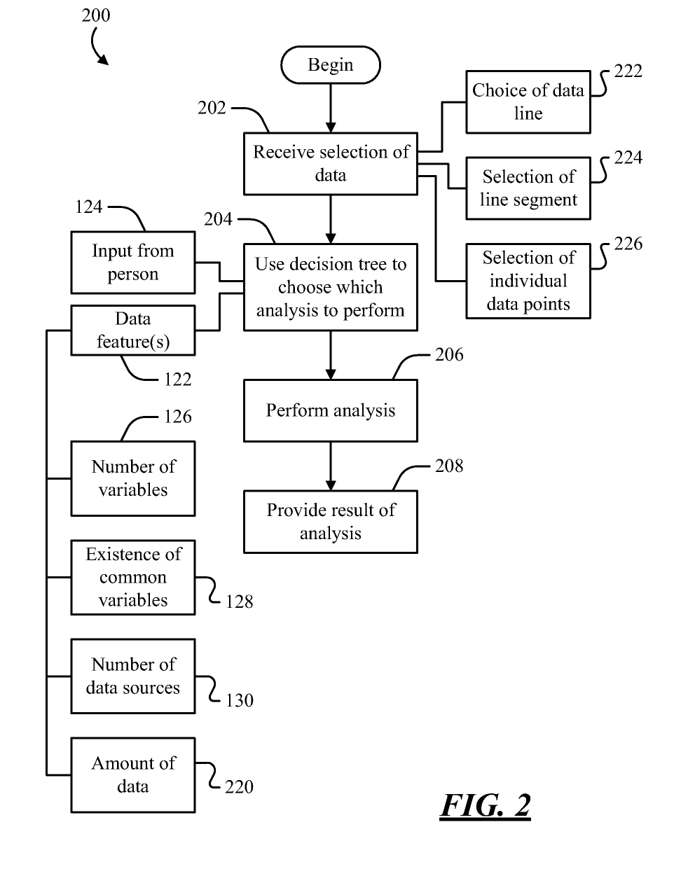

Turning now to the drawings, FIG. 1 shows an example process 100 in which data is analyzed. The flow diagram of FIG. 1 (as well as that of FIG. 2), shows an example in which stages of a process are carried out in a particular order, as indicated by the lines connecting the blocks, but the various stages shown in these diagrams can be performed in any order, or in any combination or sub-combination. Moreover, it is noted that the processes of FIGS. 1 and 2 may be carried out using the systems described herein, but could also be carried out in any system.

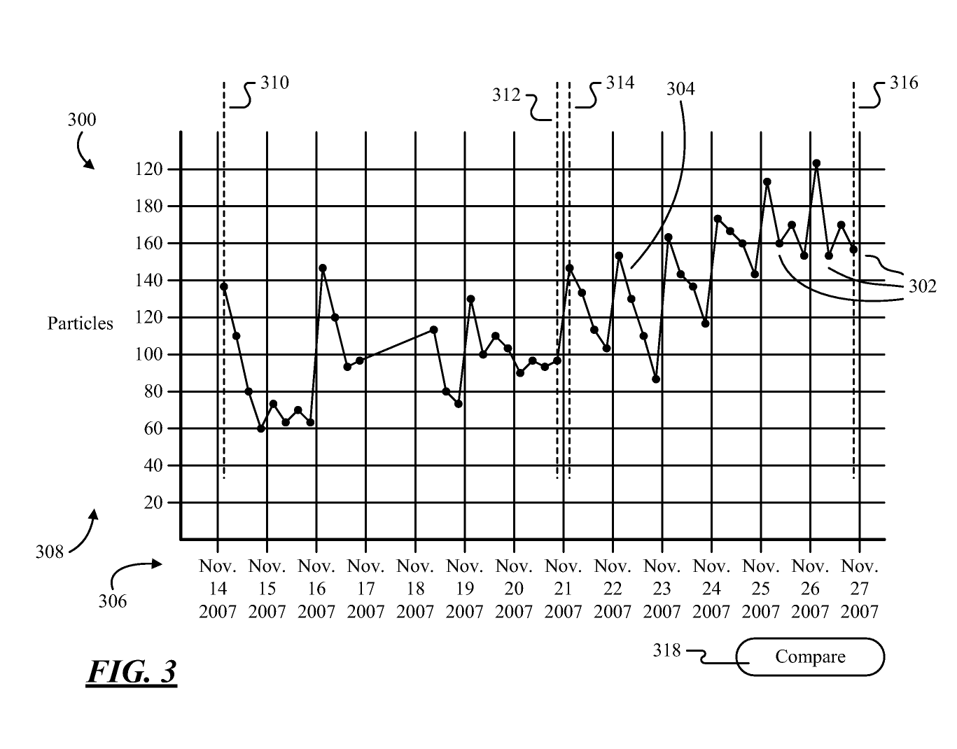

At 102, a visual interface is provided, which may provide a person with a representation of some underlying source of data. Web content that may be viewed through a web browser is one example of such a visual interface. For example, a web server may run an application that provides access to some underlying body of data. The body of data could be in the form of a database (e.g., a MIRCOSOFT SQL SERVER database, an ORACLE database, etc.) The application may be a web application that provides access to the underlying source of data by generating and providing Hypertext Markup Language (HTML) web pages that allow a person to view and/or interact with the data through a web browser. Such an arrangement provides one example of how a person can be given access to data through a visual interface. However, a visual interface to data could take any form. The visual interface may present the data in the form of a graph or plot, such as that shows in FIG. 3. However, the data could be presented in other forms, such a bar chart, pie chart, table, etc.

At 104, an indication of one or more data sets to be analyzed is received. This indication may be received through the visual interface that was provided at 102. For example, the data may be pairs of values. These pairs could be represented as a line, plotted against two axes. The line and the axes could be presented to a person as a web page, displayed on a web browser. The person could then select, for further analysis, the data represented by the line by clicking on the line. Or, the user could select some portion of the data by selecting starting and ending points along the line. (The portion selected could be the entire body of data, or it could be less than the entire body of data.) In addition to these examples, the data to be analyzed could be selected in any manner.

At 106, the sufficiency of the quantity of data is assessed. For example, it might be decided that n data points (e.g., n=5) is enough to perform a statistical analysis, and that fewer than n data points is not enough. If the quantity of data is insufficient, then no analysis is performed (at 108). The notion of what constitute a sufficient quantity of data could be based on any criteria. Setting a minimum number of data points, as described above, is one example of such a criterion, but any type of criteria could be used.

If the quantity of data is sufficient, then an analysis to be performed on the data is selected (at 110). The particular analysis to be performed may be based on one or more features of the data (block 122) and/or input from a person (block 124) indicating a particular type of analysis to be performed. There are various statistical analyses that may be performed on data sets. The particular analyses that could be performed on the data sets may be based on one or more features of the data sets themselves and/or of the relationship between different data sets. For example, the number of variables in the data sets (block 126), the existence of common variables across different data sets (block 128), and/or the number of data sources from which the data sets taken (block 130) may suggest particular analyses that could be performed. A person could provide input requesting that a particular type of analysis be performed. Or, features of the data might suggest two or more possible analyses that could be performed on the data, and a person could be asked which of the possible analyses is to be performed.

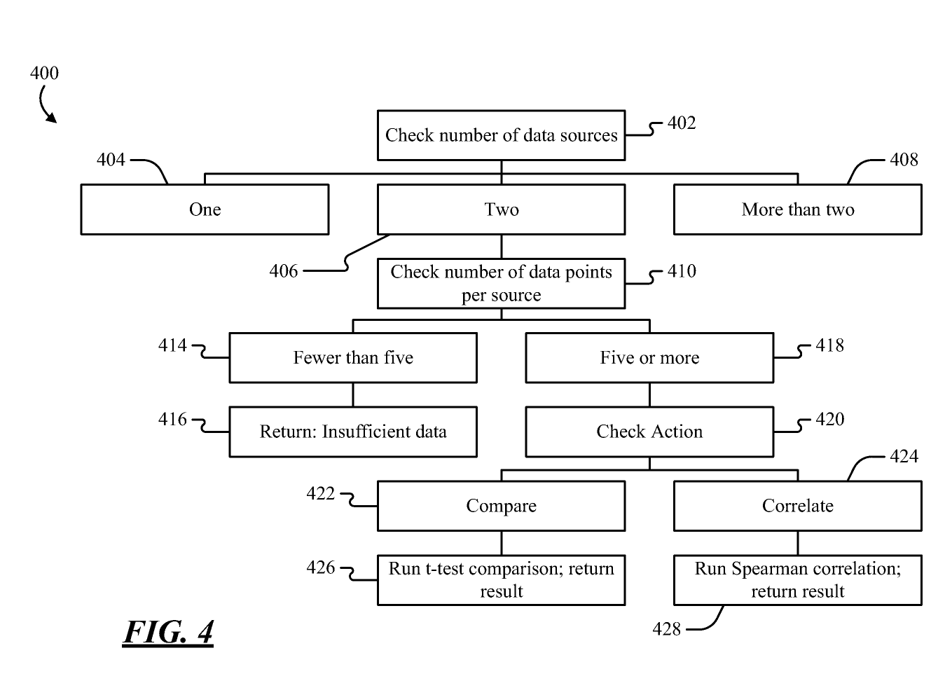

One way to determine what type of analysis is to be performed on the data is to use a decision tree, although any other mechanism (e.g., a Bayesian probability model, or any other technique) could be used to make that determination. Such a decision tree may take into account data features, user input, the sufficiency of the amount of data received, or any other factors. An example of such a decision tree is shown in FIG. 4, and is described below.

After the analysis to be performed is selected, that analysis may be performed (at 112) on the data that had been indicated at 104. For example, various statistical tests or other functions could be performed on the data. The results of the analysis are then provided (at 114). One way to provide the results is for a web application to create and/or deliver a web page to a web browser, to be displayed to a person. This web page could be presented as a graph, a chart, a table, or in any other form.

FIG. 2 shows an example process 200 in which a decision tree may be used to decide which test to perform on one or more data sets. (As noted above, a decision tree is one way to decide which test to perform, although any mechanism could be used to make that decision.) At 202, a selection of data is received. As described above, one way to receive this selection is to present a visual representation of data to a person (e.g., as a chart, graph, etc.), and to allow the person to indicate, on that visual representation, which portion of the data is to be analyzed by selecting some element of the visual representation. For example, if the data comprises pairs of values, then the data could be represented as a line graph. A person could interact with the graph by clicking on the line to indicate the selection of the data that is represented by the line (block 222). Or, the person could select some subset of the data represented by the line, such as by clicking on individual data points along the line (block 226). As a further example, a person could select some region of the visual representation, such as a line segment delimited by starting and ending points along the line (block 224). Selecting such a region may have the effect of selecting those data points whose corresponding position, in the visual representation, is within the selected region.

At 204, a decision tree may be used to determine what analysis (or analyses) is to be performed on the data that was selected at 202. An example of such a decision tree is shown in FIG. 4 and is described below. The decision tree may take into account various features of the data to be analyzed (block 122) and/or input from a person (block 124). Examples of feature of the data that could be taken into account include: the number of variables in the data (block 126), existence of common variables across data sets (block 128), the number of data sources (block 130), and the amount of data contained in the data sets (block 220) (e.g., whether the amount of data in a data set is sufficient to perform an analysis of the data). Additional or alternative features of the data could also be considered. The decision tree may combine data features and input from a person in making a decision. For example, given particular data sets that have been selected, the decision tree may determine that either a t-test comparison or a Spearman correlation (two different types of statistical analyses) could be performed on the data. A person may then be asked to choose among the different types of analyses that could be performed.

At 206, the analysis that has been chosen is performed. At 208, the results of the analysis are provided. As noted above in connection with FIG. 1, the results could be provided in the form of a web page that is viewable on a web browser, but, alternatively, could be provided in any other form.

FIG. 3 shows an example of a visual representation 300 of data. In this example, the underlying data represented by visual representation 300 indicate particulate airborne pollution at various times between Nov. 14, 2007 and Nov. 28, 2007. Each datum is a pair that contains a date/time and a number of particles (per unit volume) observed in the air at a given date and time. (The vertical lines that rise from each date may be interpreted at midnight on that date. Data points that appear between the vertical lines may represent observations taken at various times during that day.) The data are shown visually by dots 302. A line 304 may be plotted through the dots 302. (If there is more than one data set, then the different data sets could be represented by drawing separate lines through the points that represents each data set. A person could select a particular data set by selecting that set's corresponding line.) Axes 306 and 308 indicate what each object in a pair represents: date/time in axis 306, and observed particles in axis 308. Dots 302, line 304, and axes 306 and 308 are part of visual representation 300.

Visual representation 300 is an example way that data could be presented to a person. For example, a web application may create visual representation 300 to show some underlying data, and may create a web page that contains visual representation 300. This web page could be delivered to a web browser, where it may be displayed.

A person may interact with visual representation 300. For example, suppose that a person wants to know whether air pollution was higher in the week of November 21 than it was in the week of November 14. The person could, for example, use an input device (e.g., a pointing device such as a mouse or touchpad, the arrow keys on a keyboard, etc.) to select regions of the graph corresponding to each week. For example, the person could use these input mechanisms to indicate the start- and end-points of each week (as indicated by lines 310 and 312 delineating the week from November 14 to November 20, and lines 314 and 316 delineating the week from November 21, to November 27). A data region could also be specified by drag-selecting (e.g., clicking a mouse button at the start of a data region, moving the mouse through the region, and releasing the button at the end of the region). The person could then indicate in some manner that a comparison of the two regions is to be performed (e.g., by clicking button 318, marked “compare”), or the determination to perform such a comparison could be interred by a system that implements the mechanisms described herein.

In addition to the example shown in FIG. 3, there are other ways that a person could interact with data that is shown visually. For example, visual representation 300 could contain two or more lines (e.g., representing particle count at various date/times for two or more different geographic locations). The person could select one or more of the lines (e.g., by pointing at a line and clicking), and/or could select specific regions of specific lines. A given line (or a given region of a given line) may constitute a data set. As another example, a person could select individual data points on the graph (e.g., by clicking individual instances of dots 302). Once such data sets have been selected, an analysis may be performed on the data set. The analysis to be chosen could be determined based on user input (e.g., there may be buttons, or other input elements, that allow a person to choose the analysis to be performed), based on the nature of the data that has been selected (e.g., number of variables, commonality of variables across data sets, etc.), or based on a combination of these or other factors.

FIG. 4 shows an example decision tree 400 that may be used to decide what, if any, analysis is to be performed on data. Decision tree 400, in this example, comprises nodes 402-428. Decision tree 400 may be implemented in any manner. For example, program code could be created that implements the logic represented by decision tree 400. As another example, data that represents the logic of decision tree 400 could be created, and a decision engine (which may take the form of a computer program) may carry out the decisional logic represented by the data.

Node 402 represents a check as to the number of sources of data. For example, a data line, or a region of a data line, may constitute a data set, and any such data set could be considered a source of data. Decision tree 400 branches to nodes 404, 406, or 408, depending on whether the number of sources of data is one, two, or more than two. In order for a particular type of analysis to be applicable, there may be a constraint on the number of data sources, such that the analysis is performed if it is determined that the constraint is satisfied. For example, some analyses may be applicable to data having one source, two sources, more than two sources, etc. The branch to node 404, 406, or 408 represents a choice based on the number of data sources. FIG. 4 shows how the decision would progress in the case where the number of data sources is two. Thus, an additional portion of decision tree 400 is shown as being a descendant of node 406. Nodes 404 and 408 (representing one data source, and more than two data sources, respectively), could have descendants, which would indicate how the decision would progress in the event that there were one data source or more than two data sources.

Assuming that the number of data sources has been determined to be two, then the number of data points that exist in each source may be determined (as indicated at node 410). As previously noted, some analyses may involve having a sufficient quantity of data. Node 410 represents an example determination of whether the quantity of data is sufficient to perform an analysis. In the example of FIG. 4, at least five data points per source are considered sufficient. If there are fewer than five data points per source (as indicated at node 414), then the process terminates, and returns “insufficient data” as a reason for the termination (as indicated at node 416). If there are five or more data points per source (as indicated at node 418), then a determination is made as to what type of action to perform on the two data sources (as indicated at node 420).

Two possible analyses that could be performed are to compare data sets (node 422), or to correlate data sets (node 424). As previously noted, the decision as to what analyses to perform may be based on input from a person. Since comparison and correlation are examples of two different analyses that could be performed on two data sets, a person may be asked which of these analyses is to be performed. Thus, decision tree 400 may implement a process that takes into account a blend of data features and human input in order to decide what analysis to perform. However, in another example, there may be some reason to believe that people are more likely to perform one analysis or the other on certain types of data, and thus a system implements decision tree 400 could choose one of these analyses based on such a reason without soliciting input from a person. Or, such a system could make a guess as to which analysis a person is more likely to want to perform, and could then ask the person to confirm this choice.

If it is decided that a comparison analysis is to be performed, then such a comparison (e.g., a t-test comparison) may be performed on the data, and the result may be reported (as indicated at node 426). A t-test is an example of a comparison that evaluates whether two sets of data are statistically different from each other. If it is decided that a correlation analysis is to be performed, then such an analysis (e.g., a Spearman correlation) may be performed, and the result may be reported (as indicated at node 428). A Spearman correlation is an example of a statistical analysis that determines the strength and direction of correlation between two variables. The t-test comparison and Spearman correlation are examples of two statistical analyses that could be performed. However, a system that implements the subject matter described herein could offer any type of analysis.

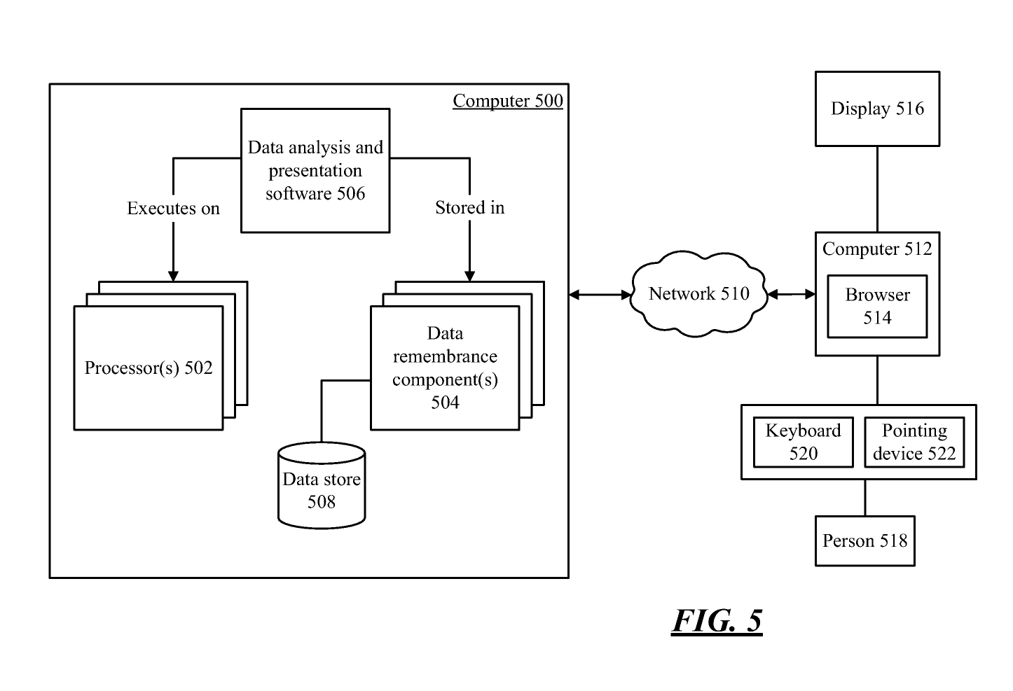

FIG. 5 shows an example environment in which aspects of the subject matter described herein may be deployed.

Computer 500 includes one or more processors 502 and one or more data remembrance components 504. Computer 500 is an example of a machine. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media.

Software may be stored in the data remembrance component(s) 504, and may execute on the one or more processor(s) 502. An example of such software is data analysis and presentation software 506, which may implement some or all of the functionality described above in connection with FIGS. 1-4, although any type of software could be used. In one example, functionality of data analysis and presentation software 506 is split across various different components. For example, there may be a database component that manages, stores, and retrieves data, and performs statistical and other analyses on data; a middleware component that determines what statistical tests to perform (e.g., by applying a decision tree, such as that shown in FIG. 4) and issues requests to the database component to have those tests performed; and a web application that provides a visual interface to data by creating and delivering web pages that are viewable on a browser. However, the subject matter described herein may be implemented using any type of software, and the functionality of such software may be in a single component, or may be divided across any number of components.

Data store 508 may store information relating to analyses that have been performed. For example, data store 508 may store the underlying data on which an analysis is performed, the result of the analysis, a timestamp, and/or any other information.

Software 506 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions are on the same medium.

In one example environment, computer 500 may be communicatively connected to one or more other devices through network 510. Computer 512, which may be similar in structure to computer 500, is an example of a device that can be connected to computer 500, although other types of devices may also be so connected. Computer 512 may, for example, comprise or make use of a browser 514, which allows a user to interact with certain types of content, such as HTML. Computer 512 may comprise, or be associated with, display 516, which may be a cathode ray tube (CRT) monitor, a liquid crystal display (LCD) monitor, or any other type of monitor. In one example, functionality is divided between computers 500 and 512 as follows: Computer 500 may have software that presents a visual interface to data, determines what analysis to perform on the data, and performs that analysis. Computer 512 may be connected to computer 500 (e.g., through the Internet or any other network). A person 518 may operate computer 512 in order to interact with the data and to direct the analysis to be performed. Computer 512 may comprise, or be connected to, input devices such as keyboard 520 and pointing device 522, in order to facilitate this interaction. While the preceding describes a particular example of how functionality may be split across computers 500 and 512, the functionality described herein may reside on a single computer, or may be divided across plural computers in any manner.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media having computer-executable instructions that, when executed, perform a method of providing data analysis, the method comprising:
providing a visual interface that includes a representation of data;
receiving, through said visual interface, an indication of a portion of said data to be analyzed;
selecting, based on a feature of said portion of said data, a first analysis to be performed on said portion of said data; and
providing a result of said first analysis to a person.

2. The one or more computer-readable storage media of claim 1, wherein said selecting comprises:
using a decision tree to select said first analysis from among a plurality of analyses, said decision tree taking into account either: (a) said feature, (b) input from said person, or (c) both said feature and said input.

3. The one or more computer-readable storage media of claim 1, further comprising:
determining that said portion of said data includes at least a certain number of data points.

4. The one or more computer-readable storage media of claim 1, wherein said feature comprises a number of variables in said portion of said data, and wherein the method further comprises:
determining that said first analysis is performable on data having said number of variables.

5. The one or more computer-readable storage media of claim 1, wherein said portion comprises a first data set and a second data set, and wherein the method further comprises:
determining that said first data set and said second data set have a variable in common.

6. The one or more computer-readable storage media of claim 1, wherein said data is based on a plurality of sources, wherein said feature comprises a number of sources, and wherein the method further comprises:
determining how many sources said portion is based on.

7. The one or more computer-readable storage media of claim 1, wherein said first analysis or a second analysis is performable on data having said feature, and wherein the method further comprises:
requesting that said person choose said first analysis or said second analysis; and
receiving, from said person, a choice to perform said first analysis.

8. The one or more computer-readable storage media of claim 1, wherein said receiving comprises:
receiving a drag-selection of a region of said representation of said data, said portion comprising one or more data points in said region.

9. The one or more computer-readable storage media of claim 1, wherein said receiving comprises:
receiving identifications of individual data points that are included among said data, said portion comprises said individual data points.

10. The one or more computer-readable storage media of claim 1, wherein said data comprises a plurality of data sets, wherein said representation comprises a plurality of lines corresponding to said plurality of data sets, and wherein said receiving comprises:
receiving a selection a line from among said plurality of lines, said portion comprising one of said data sets that corresponds to said line.

11. A method of analyzing data, the method comprising:
receiving a selection of a portion of the data;
using a decision tree to select, from among a plurality of analyses, a first analysis to be performed on said portion of the data, said decision tree taking into account a feature of said portion of the data;
performing said first analysis on said portion of the data; and
providing a result of said first analysis to a person.

12. The method of claim 11, further comprising:
providing a visual representation of said data, wherein the selection is received through a person's interaction with said visual representation.

13. The method of claim 12, wherein said providing of said visual representation comprises:
delivering a web page, which comprises said visual representation, to a machine to be displayed by a browser that executes on said machine, wherein said interaction comprises a selection of an element of said visual representation.

14. The method of claim 11, wherein said feature comprises:
a number of variables involved in said portion.

15. The method of claim 11, wherein said portion comprises a first data set and a second data set, and wherein said feature comprises:
existence of a variable in common between said first data set and said second data set.

16. The method of claim 11, wherein said first analysis is performable on data that satisfies a constraint as to a number of sources, and wherein the method further comprises:
determining that said portion satisfies said constraint as to said portion's number of sources.

17. The method of claim 11, further comprising:
determining that said portion includes at least a certain number of data points.

18. The method of claim 11, wherein said using said decision tree comprises:
determining that said first analysis or a second analysis is performable on said portion;
determining that said decision tree calls for input from said person when said first analysis or said second analysis is performable; and
receiving, from said person, an indication that said first analysis is to be performed.

19. A system comprising:
a processor;
a first component that executes on said processor, that provides a visual representation of data, and that allows a person to interact with said visual representation to indicate a portion of said data on which an analysis is to be performed; and
a second component that executes on said processor and that selects, based on a feature of said portion, said analysis, from among a plurality of analyses, to be performed on said data and that issues a request that said analysis be performed, said first component providing a result of said analysis to said person.

20. The system of claim 19, wherein said first component generates a web page that comprises said visual representation, delivers said web page to a computer that is operated by said person, and receives, from said computer, information indicative of said portion indicated by said person.
